(19) United States
(12) Patent Application Publication
(10) Pub. No.: US 2021/0209175 A1
(43) Pub. Date: Jul. 8, 2021

(54) WEB CRAWLING SYSTEM BASED ON SOFTWARE AS SERVICE

(71) Applicant: UPENNSOLUTION Co., Ltd., Seoul (KR)

(72) Inventor: Jae Hun KIM, Gyeonggi-do (KR)

(21) Appl. No.: 16/952,800

(22) Filed: Nov. 19, 2020

(30) Foreign Application Priority Data
Jan. 2, 2020 (KR) 10-2020-0000388

(51) Int. Cl. G06F 16/951; G06F 16/955; G06F 16/901

(52) U.S. Cl. CPC G06F 16/951; G06F 16/901; G06F 16/955

(57) ABSTRACT

A web crawling system based on SaaS according to an embodiment of the present disclosure may easily select data to be collected and collect the data in terms of a user interface. The web crawling system based on SaaS according to an embodiment of the present disclosure includes: a URL input unit; a task window display unit; a workflow setting unit; and a web crawling execution unit.

### CROSS-REFERENCE TO RELATED APPLICATION(S)

This application claims the benefit under 35 USC § 119(a) of Korean Patent Application No. 10-2020-0000388, filed on Jan. 2, 2020, in the Korean Intellectual Property Office, the entire disclosure of which is incorporated herein by reference for all purposes.

### BACKGROUND

### 1. Field

An embodiment of the present disclosure relates to a web crawling system based on software as a service (SaaS).

### 2. Description of Related Art

Software for collecting web page information is referred to as a crawler (or spider), and search engines of GOOGLE, NAVER, or the like use crawlers to collect and store websites all over the world.

In this case, the crawler may be classified into an installation type, which is installed in the OS (operating system) of a user and collects data, and a cloud type, which is a web service in the form of a software as a service (SaaS).

The installation-type crawler is inexpensive, but requires the personal computer (PC) to be turned on to collect data, and thus when a power outage occurs, or the user turns off the PC, it is not possible to collect data. In addition, since one internet protocol (IP) is used, the probability of IP being blocked is high, and since PC specifications and network speed are limited, it may lead to suppression of quick collection of a large amount of data.

In the cloud-type crawler in the form of the software as a service (SaaS), it is possible to increase the performance of a server (i.e., scale-up) or increase the number of servers (i.e., scale-out) by using the cloud service, which makes it possible to increase the speed of data collection, use almost unlimited IPs, and collect data from web pages in countries with access area restrictions. However, it is difficult to use the above-mentioned crawler, and thus no one uses it for personal purposes except for program developers or students for research purposes.

### SUMMARY

An embodiment of the present disclosure provides a web crawling system based on software as a service (SaaS) capable of easily selecting data to be collected and collecting the data in terms of a user interface.

In one general aspect, there is a provided a web crawling system based on SaaS including: a uniform resource locator (URL) input unit configured to receive a URL of a website from which data is to be extracted through web crawling; a task window display unit configured to display, through a plurality of task windows, each web page included in the website of the URL input through the URL input unit; a workflow setting unit configured to display an extractable data area in each of the task windows, select data in the data area to set the selected data as target data to be extracted, define a data range to be repeatedly extracted from web pages of the task windows, select link data in the task windows to link web pages from which data is to be extracted, and display the linked web pages on each of the task windows; and a web crawling execution unit configured to execute web crawling according to items set and defined through the workflow setting unit to provide a crawling result.

The workflow setting unit may include: an extraction function menu unit is configured to activate the task windows loaded through the task windows display unit when a first function is selected, display the extractable data area in the task windows, and select data in the data area to set the selected data as the target data to be extracted; a task repetition function menu unit configured to, specify a range of preset rows and columns depending on whether first two consecutively selected pieces of data in the task windows are in different columns and in the same row or whether the first two consecutively selected pieces of data in the task windows are in the same column and in different rows and set data in the specified range of rows and columns as the target data to be extracted, wherein data to be selectable from the data area is arranged in rows and columns, the same column of data has the same structure and pattern, and different columns of data have different structures and patterns; a click function menu unit configured to display the link data in the task windows as selectable when the first function is selected, and display a new web page according to the link data as a detailed page when the link data is selected and link the new web page to the current web page to display each of the web pages on the task windows; and a pagination function menu unit configured to repeatedly extract the target data to be extracted which is set through the extraction function menu unit and the task repetition function menu unit for each web page created through the click function menu unit.

The extraction function menu unit may display whether or not data of the extractable data area in the task windows is set as the target data to be extractable when the extractable data area in the task windows is moused over.

The task repetition function menu unit may: when the first two consecutively selected pieces of data in the task windows are in different columns and in the same row, specify a range of columns according to the two consecutively selected pieces of data and then additionally specify a range of rows consisting of the number of preset rows within the specified range of columns when a different row of data is selected among data within the specified range of columns, thereby finally setting data within the specified ranges of rows and columns as the target data to be extracted, and when the first two consecutively selected pieces of data in the task windows are in the same column and in different rows, specify the range of rows consisting of the number of preset rows for the column including the two consecutively selected pieces of data and then additionally specify a range of columns consisting of a selected number of columns when a different column of data is selected among data within the range of rows, thereby finally setting data within specified ranges of rows and columns as the target data to be extracted.

The web crawling execution unit may include: a crawling preview performing unit providing a preview of temporarily extracted data and edit functions for columns, the data being within the ranges of columns and rows specified through the task repetition function menu unit; a crawling performing unit executing web crawling on each piece of data displayed through the preview; and a crawling history providing unit providing a crawling progress of the crawling execution unit, a detailed crawling history, and a crawling result.

The pagination function menu unit may be configured to activate each of the task windows, select a plurality of consecutive web pages from a first web page among the web pages displayed in the task windows, and repeatedly extract the target data to be extracted which is set through the extraction function menu unit and the task repetition function menu unit in units of selected pages.

According to the present disclosure, it is possible to provide a web crawling system based on SaaS capable of easily selecting data to be collected and collecting the data in terms of a user interface.

### BRIEF DESCRIPTION OF THE DRAWINGS

FIG. 1 is a schematic diagram illustrating a configuration scheme of a web crawling system based on SaaS according to an embodiment of the present disclosure.

FIG. 2 is a block diagram illustrating an architecture of the web crawling system based on SaaS according to an embodiment of the present disclosure.

FIG. 3 is a block diagram illustrating an overall configuration of the web crawling system based on SaaS according to an embodiment of the present disclosure.

FIG. 4 is a block diagram illustrating a detailed configuration of a workflow setting unit according to an embodiment of the present disclosure.

FIG. 5 is a block diagram illustrating a detailed configuration of a web crawling execution unit according to an embodiment of the present disclosure.

FIG. 6 is a diagram illustrating an execution screen of a URL input unit according to an embodiment of the present disclosure.

FIGS. 7 to 17 are diagrams illustrating execution screens of the workflow setting unit and the web crawling execution unit according to an embodiment of the present disclosure.

FIG. 18 is a diagram illustrating an execution screen of the web crawling execution unit according to an embodiment of the present disclosure.

### DETAILED DESCRIPTION

Terms used in the present specification will be briefly described, and the present disclosure will be described in detail.

The terms used in the present invention are selected from common terms that are currently and widely used in consideration of functions in the present disclosure. However, the terms may vary depending on the intentions of those skilled in the art, precedents, appearances of new technologies, and the like. In addition, there are some terms arbitrarily selected by the applicant. In this case, the meanings of the terms will be described in detail in the following detailed description. Therefore, the terms used in the present disclosure are not simply defined by the terms themselves but are defined by the meanings of the terms and the entire content and context of the present disclosure.

When a part “includes” an element, in the entire specification herein, unless described to the contrary, the term “includes” does not indicate that another element is excluded but instead indicates that the other element may be further included. In addition, the terms including “unit” and “module” described in the specification refer to units of performing at least one function or operation, which may be implemented by hardware or software, or by a combination of hardware and software.

Hereinafter, embodiments of the present disclosure will be described in detail with reference to the accompanying drawings so that those skilled in the art may easily perform the present disclosure. However, the present disclosure may be implemented by various modifications and is not limited to the embodiments described herein. In the drawings, in order to clarify the present disclosure, parts that are not related to description are omitted and like reference numerals represent like elements throughout the specification.

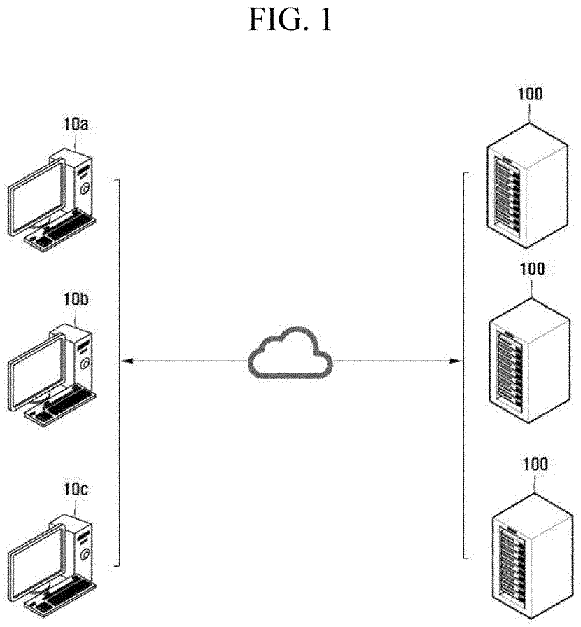

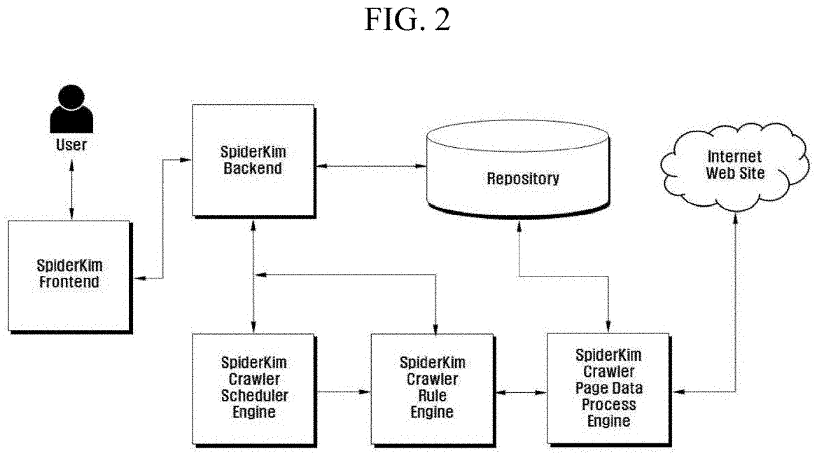

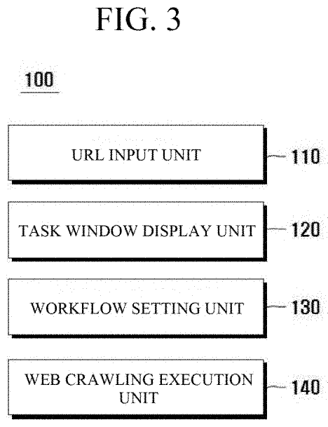

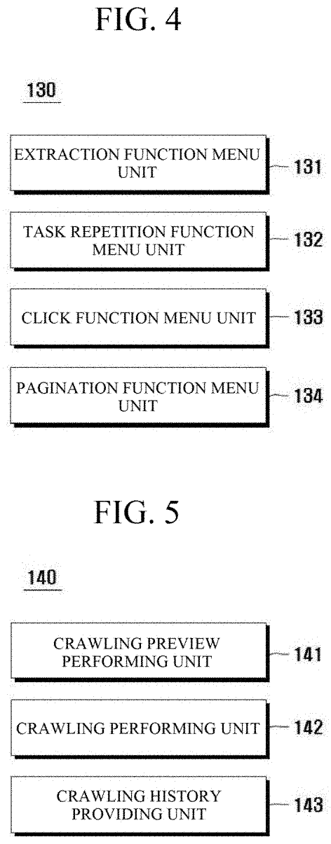

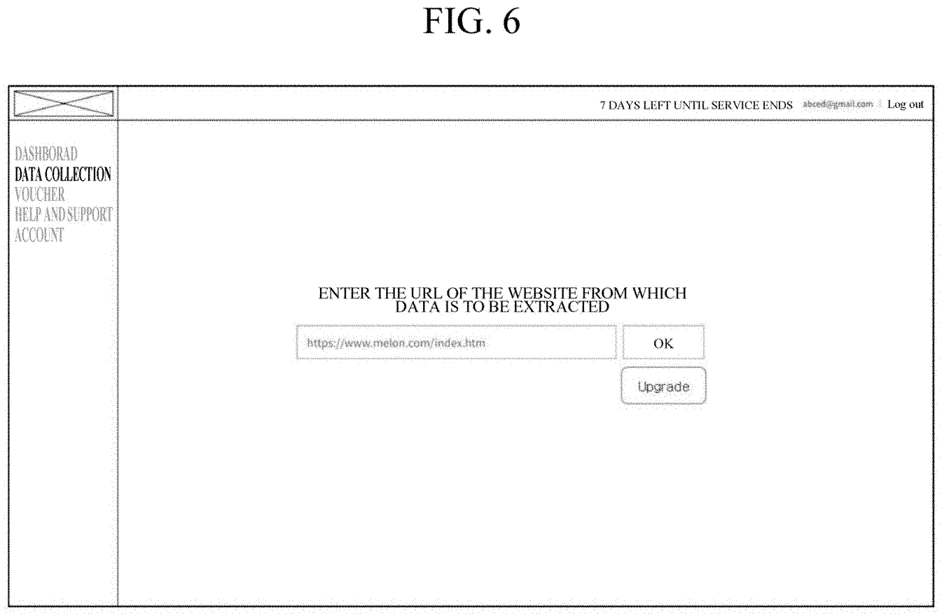

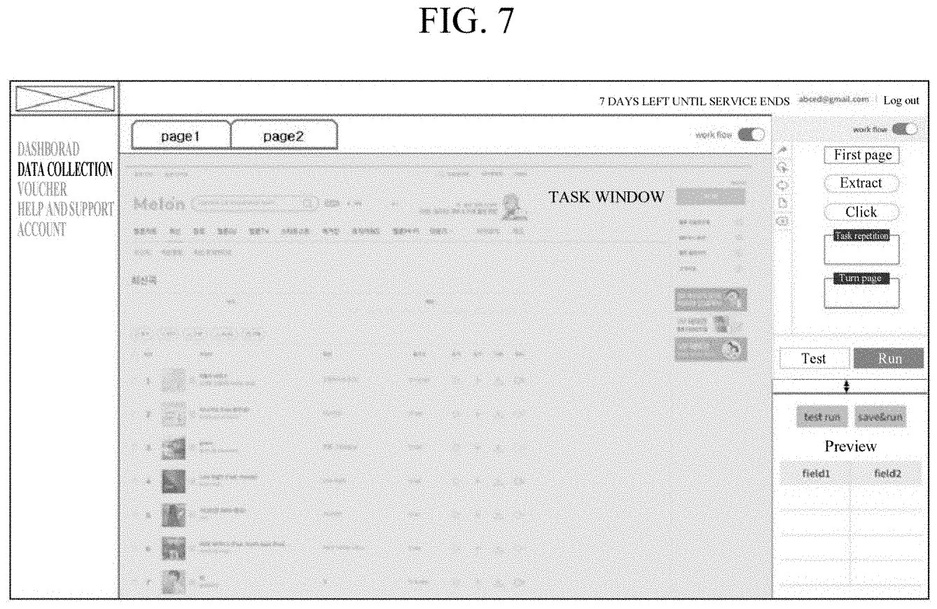

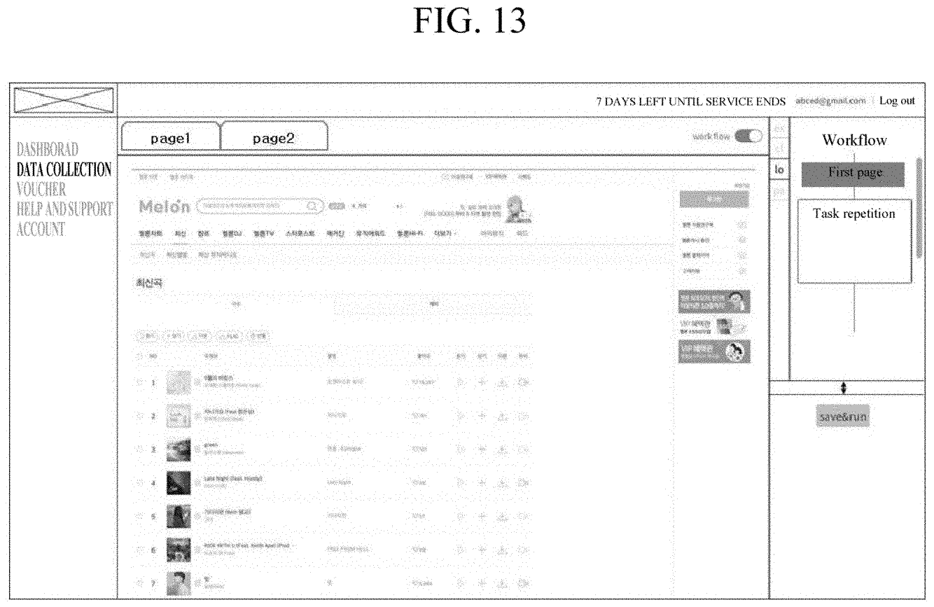

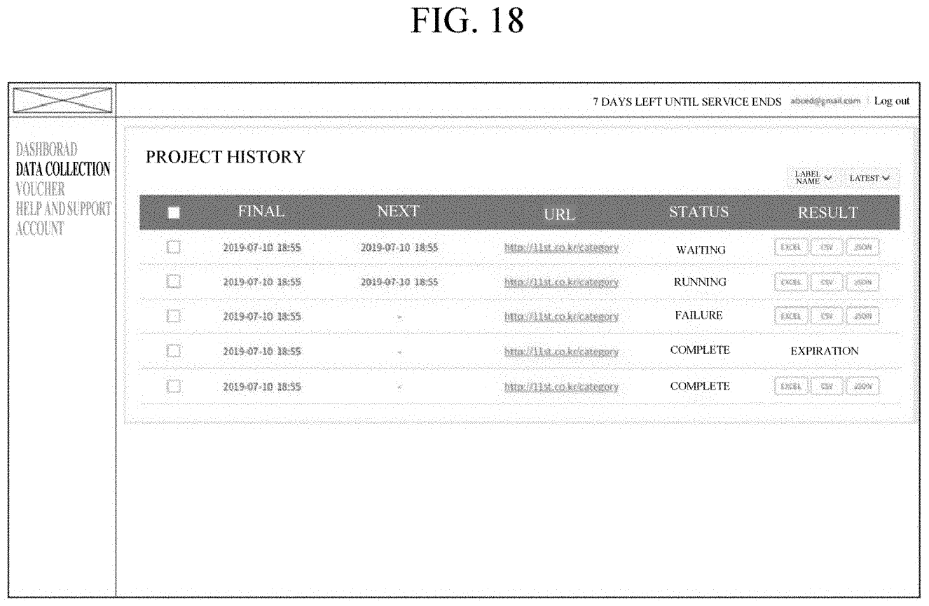

FIG. 1 is a schematic diagram illustrating a configuration scheme of a web crawling system based on SaaS according to an embodiment of the present disclosure, FIG. 2 is a block diagram illustrating an architecture of the web crawling system based on SaaS according to an embodiment of the present disclosure, FIG. 3 is a block diagram illustrating an overall configuration of the web crawling system based on SaaS according to an embodiment of the present disclosure, FIG. 4 is a block diagram illustrating a detailed configuration of a workflow setting unit according to an embodiment of the present disclosure, FIG. 5 is a block diagram illustrating a detailed configuration of a web crawling execution unit according to an embodiment of the present disclosure, FIG. 6 is a diagram illustrating an execution screen of a URL input unit according to an embodiment of the present disclosure, FIGS. 7 to 17 are diagrams illustrating execution screens of the workflow setting unit and the web crawling execution unit according to an embodiment of the present disclosure, and FIG. 18 is a diagram illustrating an execution screen of the web crawling execution unit according to an embodiment of the present disclosure.

Referring to FIG. 3, a web crawling system based on SaaS 100 according to an embodiment of the present disclosure includes a URL input unit 110, a task window display unit 120, a workflow setting unit 130, and a web crawling execution unit 140.

The URL input unit 110 may receive a URL of a website from which data is to be extracted through web crawling as illustrated in FIG. 6.

The number of remaining projects of a user ID is checked before loading the screen of the URL input unit 110, and when there is a remaining project that may be created, the task screen may be loaded, and the URL input window may be activated, and when there is no remaining project, a URL input screen is disabled, and an ‘upgrade’ button is displayed instead of an OK button.

As a project creation rule, if the input URL is different from the existing project, ‘count+’ is made as a new project. In addition, when the existing project and the URL are different, the time of ‘count+’ of the project is when the ‘save run’ button is pressed after data extraction design is completed, and web crawling is completed.

The task window display unit 120 may display, through the plurality of task windows, each web page included in a website of the URL input through the URL input unit 110, as illustrated in FIG. 7.

In this case, as a default, when the task window is loaded, the task window is disabled, and a box ‘go to Top Page’ may be created. At this time, ‘go to Top Page’ has a function of jumping from the current screen to the initial URL.

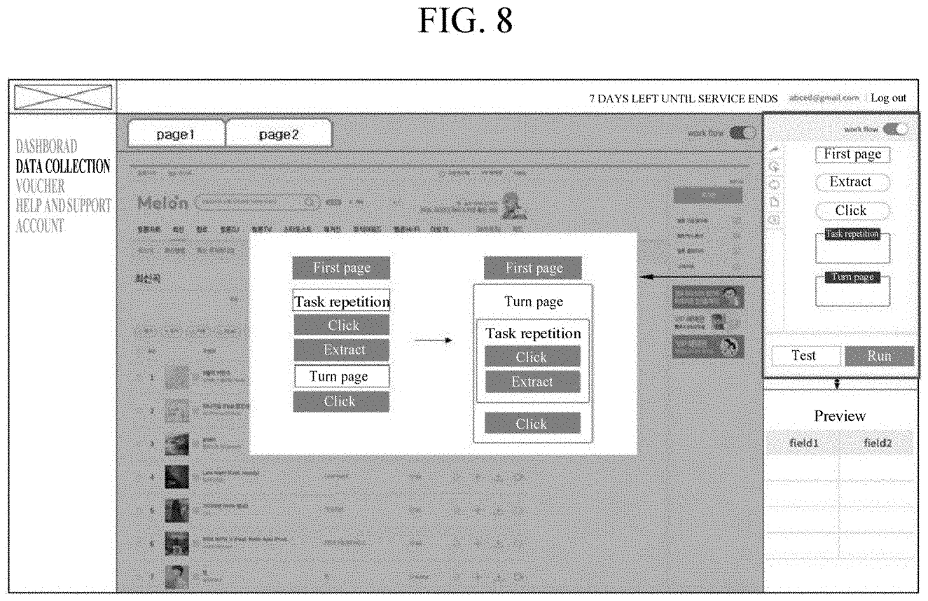

The workflow setting unit 130 may display an extractable data area in the task window, select data in the data area to set the selected data as target data to be extracted, define a data range to be repeatedly extracted from web pages of the task windows, select link data in the task windows to link web pages from which data is to be extracted, and display the linked web pages on each of the task windows. In the workflow diagram and menu operation method according to the present embodiment, as illustrated in FIG. 8, when a menu is clicked, a lower menu is added, and the user may complete the operation by moving the diagram according to the manual.

The workflow setting unit 130 may include an extraction function menu unit 131, a task repetition function menu unit 132, a click function menu unit 133, and a pagination function menu unit 134.

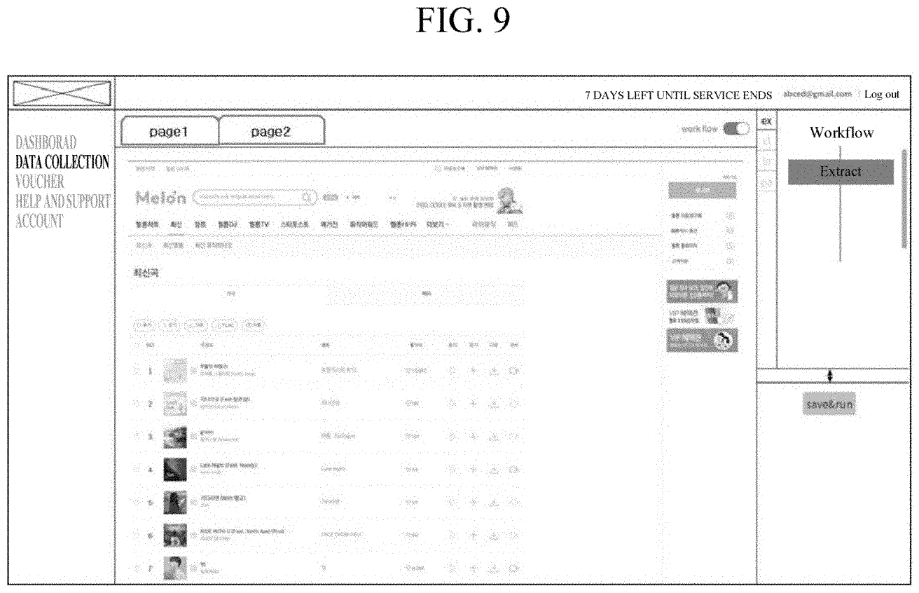

As illustrated in FIG. 9, the extraction function menu unit 131 may activate the task window loaded through the task window display unit 120 when a first function is selected, display the extractable data area in the task window, and select data in the data area to set the selected data as the target data to be extracted.

More specifically, the extraction function menu unit 131 may display whether or not data of the extractable data area in the task window is set as the target data to be extractable when the extractable data area in the task window is moused over. For example, when a mouse cursor (or mouse pen) is placed on the data area displayed in the task window, the data to be extracted may be indicated, for example, by inverting the background color of the extractable data, and when the data is selected, it may be set as the target data to be extracted.

When data to be selectable from the data area is arranged in rows and columns, the same column of data has the same structure and pattern, and different columns of data have different structures and patterns, the task repetition function menu unit 132 may be configured to specify a range of preset rows and columns depending on whether first two consecutively selected pieces of data in the task window are in different columns and in the same row or whether the first two consecutively selected pieces of data in the task window are in the same column and in different rows, and set data in the specified range of rows and columns as the target data to be extracted.

More specifically, when first two consecutively selected pieces of data in the task window are in different columns and in the same row, the task repetition function menu unit 132 may specify a range of columns according to the two consecutively selected pieces of data and then additionally specify a range of rows consisting of the number of preset rows within the specified range of columns when a different row of data is selected among the specified range of columns, thereby finally setting data within the specified ranges of columns and rows as the target data to be extracted, and thus a column (field) may be added.

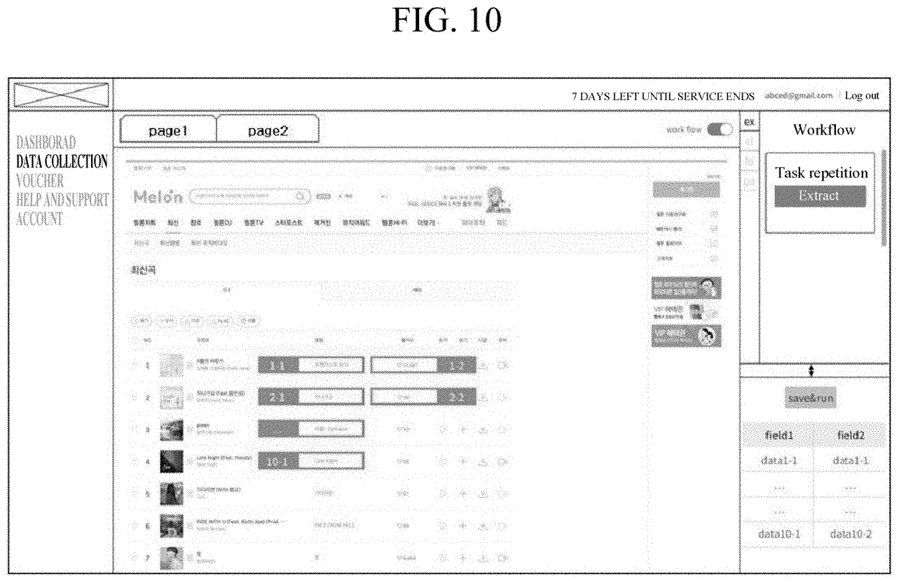

For example, referring to FIG. 10, since, when a 1-1 data and a 1-2 data are selected, they are in different columns and in the same row, the 1-1 data and the 1-2 data may have different data structures and patterns, and in such a selection, the 1-1 data and the 1-2 data may be first displayed through fields 1 and 2 illustrated in FIG. 10. In this case, a range of two columns may be first specified according to the 1-1 data and the 1-2 data, and then, when a 2-1 data in a different row in the columns is selected, the number of preset rows (e.g., 10 rows) within the specified range of columns, for example, the range of up to a 10-1 data and a 10-2 data may be additionally specified according to 10 rows, and thus data within the specified range of columns and rows may be finally specified as the target data to be extracted. The specified data may be displayed through fields 1 and 2 of a preview illustrated in FIG. 10.

Furthermore, when the first two consecutively selected pieces of data in the task window are in the same column and in different rows, the task repetition function menu unit 132 may specify a range of rows consisting of the number of preset rows for the column including the two consecutively selected pieces of data and then, additionally specify a range of columns consisting of the number of selected columns when data in different columns is selected among the data within the range of rows, thereby finally setting data within the specified ranges of columns and rows as the target data to be extracted, and thus task repetition (loop) may be automatically created.

For example, referring to FIG. 10, since when the 1-1 data and the 2-1 data are selected, they are in the same column and in different rows, the 1-1 data and the 2-1 data may have the same data structure and pattern, and in such a selection, the 1-1 data and the 2-1 data may be displayed first through the field 1 illustrated in FIG. 10. In this case, a range of two rows may be first specified according to the 1-1 data and the 2-1 data, for example, the range of up to the 10-1 data may be specified according to 10 rows, and then, when a 2-2 data in a different column within the range of rows is selected, the specified range of columns, for example, data of up to 2 columns may be additionally specified, and thus data within the specified range of columns and rows may be finally specified as the target data to be extracted. The specified data may be displayed through fields 1 and 2 of the preview illustrated in FIG. 10.

The click function menu unit 133 may be configured to display the link data in the task windows as selectable when the first function is selected, and display a new web page according to the link data as a detailed page when the link data is selected and link the new web page to the current web page to display each of the web pages on the task window.

The pagination function menu unit 134 may be configured to activate each of the task windows, select a plurality of consecutive pages from a first page among pages displayed in the task window, and repeatedly extract the target data to be extracted which is set through the extraction function menu unit and the task repetition function menu unit 132 in units of selected pages.

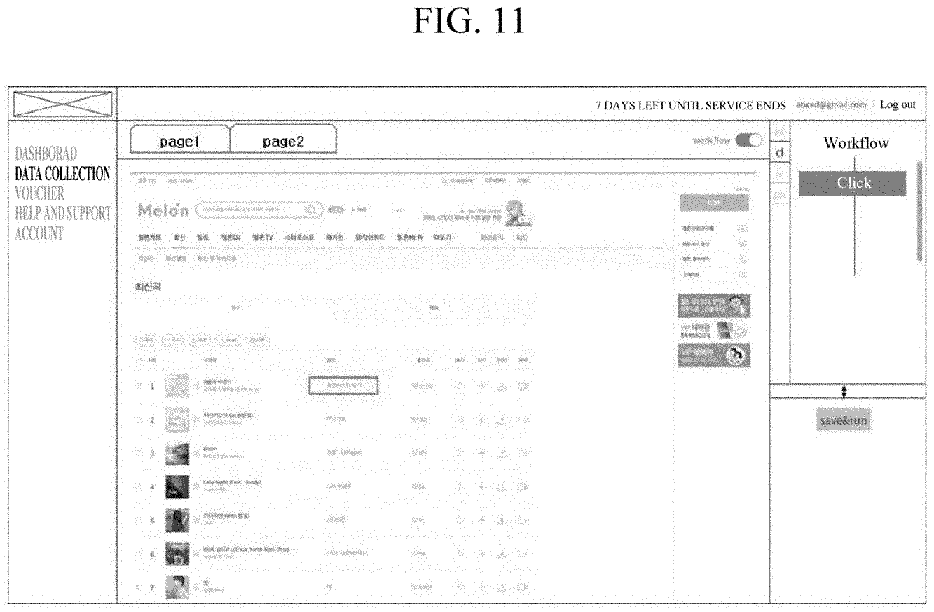

Referring to FIG. 11, in an operation method for the click function menu related to the above, when a ‘Click’ menu is selected from the ‘workflow’ menu, the task window is activated and a blue box is created, and when the part ‘data to be extracted’ with the link is clicked in the task window, it is in a standby state (as in an ‘Extract’ menu, data of the same structure changes color). At this time, when data of the same structure is selected, going to the detail page may be done and the detail page may be disabled, and when data of a different structure is selected, an error message may be displayed without going to the detail page.

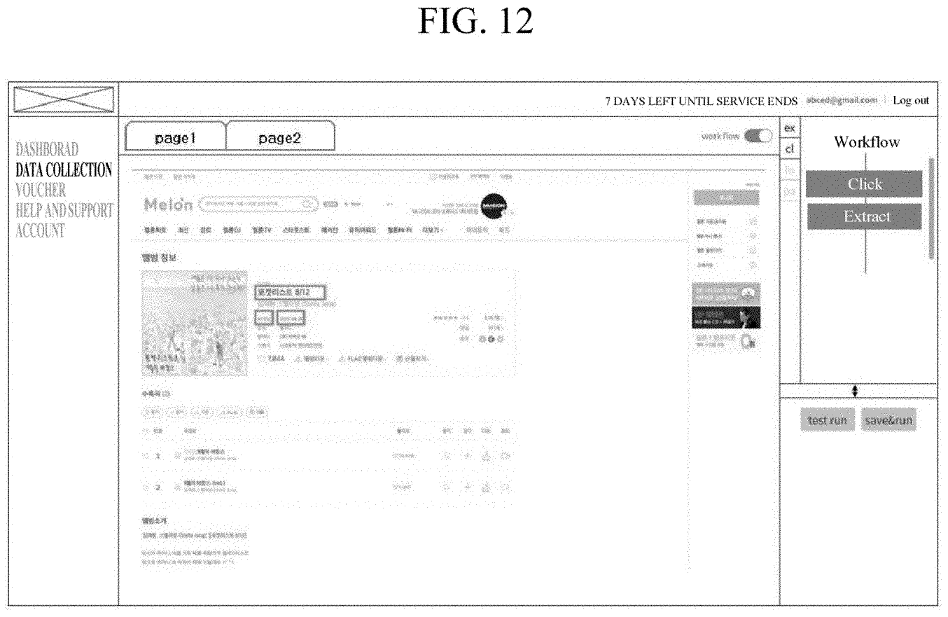

On the other hand, if the task repetition (loop) is applied to the detail page, the data extracted (Extract) from the last depth may be displayed in the preview. Then, after the diagram is completed, when the ‘Test Run’ button illustrated in FIG. 12 is pressed, only the first 5 rows of collected data of all depths are displayed, and the data collection result may be checked. In addition, after checking the data preview, the crawler may start web crawling by pressing the ‘save&run’ button illustrated in FIG. 12.

The pagination function menu unit 134 may repeatedly extract the target data to be extracted which is set through the extraction function menu unit 131 and the task repetition function menu unit 132 for each web page created through the click function menu unit 133.

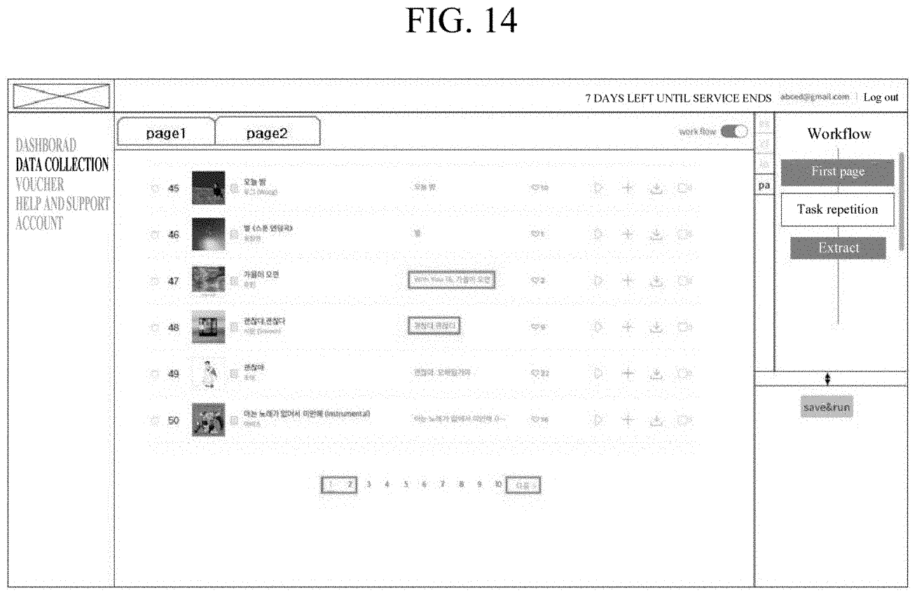

Referring to FIG. 14, in the operation method for the pagination menu, when the ‘Turn-page’ is selected from the ‘workflow’ menu, a hollow box is created in the workflow. At this time, the task window is disabled, and when the ‘click’ menu is selected, a blue box is created, and the task window is activated. Then, the turn-page may be defined by selecting the two turn-page numbers at the bottom of the page and the next button. In this case, when ‘Turn-page+Click’ is selected, waiting has to be done until the two page numbers and the next are selected, without going to the linked page, and the user has to modify the diagram according to the manual of the system.

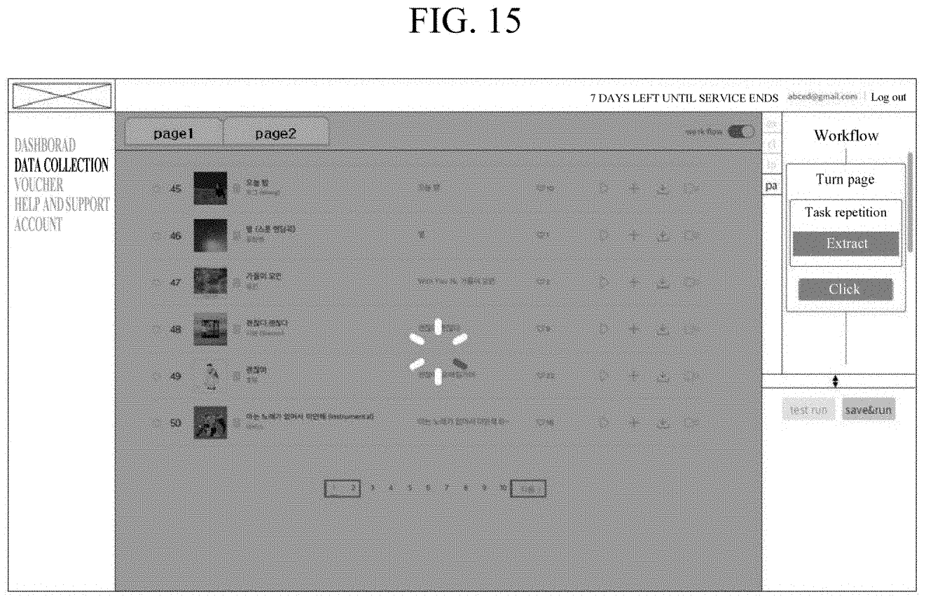

In addition, referring to FIG. 15, when the ‘Test run’ button is selected and executed, the collected data for all depths are displayed to be confirmed in the preview window, and then, when the ‘save & run’ button is pressed, crawling may be displayed through the ‘loading spinner’.

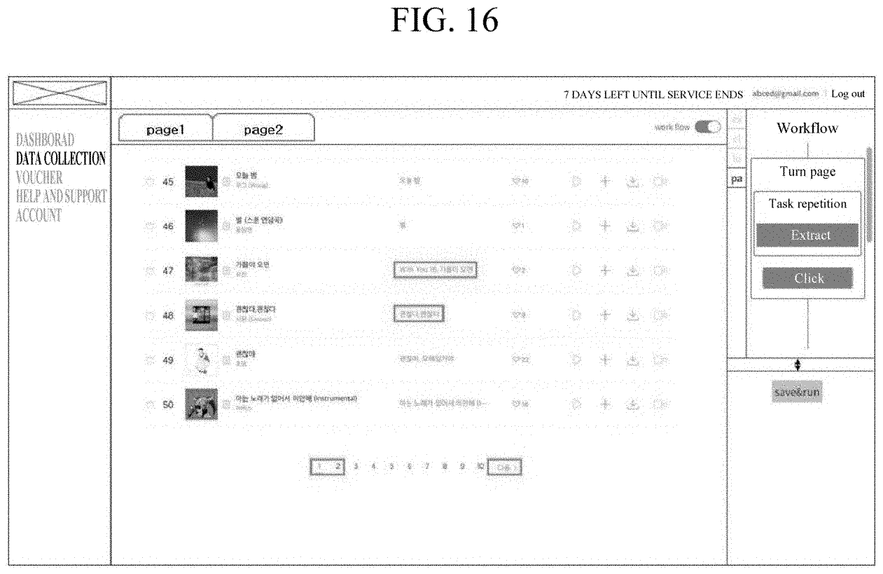

In addition, referring to FIG. 16, after clicking the ‘Extract’, data to be extracted may be selected (the menu operation principle after selection is the same as described above, and thus the description thereof will be omitted), and the task repetition (loop) may be automatically created and ‘Turn page, Click’ may be selected, and then the number 3 may be selected to set the turn-page, and then modification may be performed according to the diagram manual.

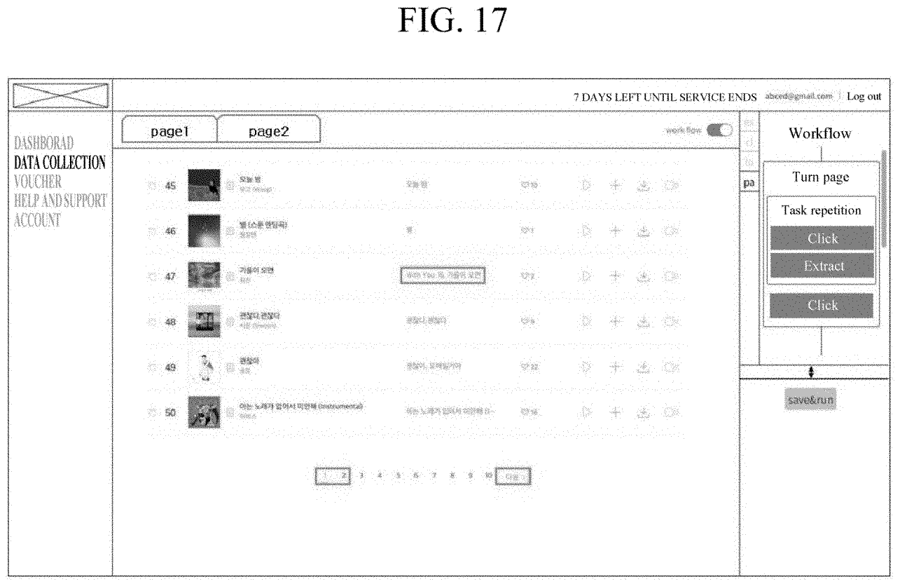

In addition, referring to FIG. 17, when a ‘Click’ button is selected and two pieces of data of the same structure are selected, the task repetition (loop) is automatically created, the page is moved to the detail page, an ‘Extract’ button is selected and then data to be extracted is selected (the menu operation principle after selection is the same as described above, and thus the description thereof will be omitted), and when a ‘First page’ button is selected, the page is moved to the main page. At this time, the task window is disabled, and after selecting the ‘turn-page, click’ button, the number 3 is selected to set the turn-page.

At this time, the ‘Turn page+Click’ is not allowed go to the detail page, and waiting is to be done until two page numbers and the next one are selected for page setting. When the ‘Click’ button is selected and then two pieces of data of the same structure are selected (2), the task repetition (loop) may be automatically created, going to the detail page may be done, and when the data to be extracted is selected after clicking the ‘Extract’ button, the corresponding data may be displayed on the preview.

The web crawling execution unit 140 may provide a crawling result for each project by executing web crawling according to the settings and definitions through the workflow setting unit 130. To this end, the web crawling execution unit 140 may include a crawling preview performing unit 141, a crawling performing unit 142, and a crawling history providing unit 143.

As illustrated in FIGS. 7, 8, and 10, the crawling preview performing unit 141 may provide the preview of temporarily extracted data and edit functions for columns, where the data are within the ranges of columns and rows specified through the task repetition function menu unit 132.

The crawling performing unit 142 may execute (start) web crawling on each piece of data displayed through the preview.

The crawling history providing unit 143 may provide a crawling progress state, a detailed crawling history, and a crawling result of the crawling performing unit 142. For example, as illustrated in FIG. 18, for each project, various information on the final execution time, the next execution time, the URL information of the website for the project, the crawling progress, and the result (downloadable) may be provided and checked.

While the present disclosure has been described with reference to an embodiment for implementing a web crawling system based on SaaS, the present disclosure is not limited to the embodiment, and it will be understood by those skilled in the art that various modifications may be made without departing from the spirit and scope of the present disclosure, as defined by the accompanying claims.

What is claimed is:

1. A web crawling system based on software as a service (SaaS) comprising:
a uniform resource locator (URL) input unit configured to receive a URL of a web site from which data is to be extracted through web crawling;
a task window display unit configured to display, through a plurality of task windows, each web page included in the website of the URL input through the URL input unit;
a workflow setting unit configured to display an extractable data area in each of the task windows, select data in the data area to set the selected data as target data to be extracted, define a data range to be repeatedly extracted from web pages of the task windows, select link data in the task windows to link web pages from which data is to be extracted, and display the linked web pages on each of the task windows; and
a web crawling execution unit configured to execute web crawling according to items set and defined through the workflow setting unit to provide a crawling result.

2. The web crawling system based on SaaS of claim 1, wherein the workflow setting unit comprises:
an extraction function menu unit configured to activate the task windows loaded through the task window display unit when a first function is selected, display the extractable data area in the task windows, and select data in the data area to set the selected data as the target data to be extracted;
a task repetition function menu unit configured to specify the range of preset rows and columns depending on whether first two consecutively selected pieces of data in the task windows are in different columns and in the same row or whether the first two consecutively selected pieces of data in the task windows are in the same column and in different rows and set data in the specified range of rows and columns as the target data to be extracted, wherein data to be selectable from the data area is arranged in rows and columns, the same column of data has the same structure and pattern, and different columns of data have different structures and patterns;
a click function menu unit configured to display the link data in the task windows as selectable when the first function is selected, and display a new web page according to the link data as a detailed page when the link data is selected and link the new web page to the current web page to display each of the web pages on the task windows; and
a pagination function menu unit configured to repeatedly extract the target data to be extracted which is set through the extraction function menu unit and the task repetition function menu unit for each web page created through the click function menu unit.

3. The web crawling system based on SaaS of claim 2, wherein the extraction function menu unit displays whether or not data of the extractable data area in the task windows is set as the target data to be extractable when the extractable data area in the task windows is moused over.

4. The web crawling system based on SaaS of claim 2, wherein the task repetition function menu unit:
when the first two consecutively selected pieces of data in the task windows are in different columns and in the same row, specifies a range of columns according to the two consecutively selected pieces of data and then additionally specifies a range of rows consisting of the number of preset rows within the specified range of columns when a different row of data is selected among data within the specified range of columns, thereby finally setting data within the specified ranges of rows and columns as the target data to be extracted; and
when the first two consecutively selected pieces of data in the task windows are in the same column and in different rows, specifies the range of rows consisting of the number of preset rows for the column including the two consecutively selected pieces of data and then additionally specify a range of columns consisting of a selected number of columns when a different column of data is selected among data within the range of rows, thereby finally setting data within specified ranges of rows and columns as the target data to be extracted.

5. The web crawling system based on SaaS of claim 4, wherein the web crawling performing unit comprises:
a crawling preview execution unit providing a preview of temporarily extracted data and edit functions for columns, the data being within the ranges of columns and rows specified through the task repetition function menu unit;
a crawling performing unit executing web crawling on each piece of data displayed through the preview; and
a crawling history providing unit providing a crawling progress of the crawling performing unit, a detailed crawling history, and a crawling result.

6. The web crawling system based on SaaS of claim 2, wherein the pagination function menu unit is configured to activate each of the task windows, select a plurality of consecutive web pages from a first web page among the web pages displayed in the task windows, and repeatedly extract the target data to be extracted which is set through the extraction function menu unit and the task repetition function menu unit in units of selected pages.
